(19) United States
(12) Patent Application Publication
(10) Pub. No.: US 2006/0205510 A1
(43) Pub. Date: Sep. 14, 2006

(54) Method and system for playing while using game terminal connected to a mobile radio network

(75) Inventors: Eric Lauper, Bern (CH); Frederic Layani, Lausanne (CH)

Correspondence Address: PEARNE & GORDON LLP, 1801 EAST 9TH STREET, SUITE 1200, CLEVELAND, OH, 44114-3108, US

(73) Assignee: Swisscom Mobile AG, Bern (CH)

(21) Appl. No.: 11/402,536

(22) Filed: Apr. 12, 2006

Related U.S. Application Data
(63) Continuation of application No. PCT/EP04/52573, filed on Oct. 18, 2004.

(30) Foreign Application Priority Data
Oct. 17, 2003 (EP) 2003EP103864
Oct. 18, 2004 (WO) 2004WO-EP052573

(51) Int. Cl. G06F 19/00; A63F 9/24; A63F 13/00; G06F 17/00

(52) U.S. Cl. 463/41; 463/42

(57) ABSTRACT

A system for games, with the following features: a mobile radio network, at least a mobile telephone as game terminal with an interface for the mobile radio network and at least one gaming application, said game terminal having a portable personal identification module, an advertising content server system for broadcasting advertising contents separately from the gaming application over said mobile radio network to said game terminal, said gaming application being programmed in such a manner that said advertising contents are reproduced in the game to the player during a game. The gaming application is programmed in such a manner that products or components advertised during the game can be ordered over said mobile radio network.

### REFERENCE DATA

This application is a continuation of International Patent Application of 2004WO-EP052573 (WO2005/036425) filed on Oct. 18, 2004 claiming Convention priority of European application 2003EP103864 (EP1524617) filed Oct. 17, 2003, the contents whereof are hereby incorporated by reference.

### FIELD OF THE INVENTION

The present invention concerns a system and a method for electronic games in a mobile radio network.

### DESCRIPTION OF RELATED ART

Gaming applications that can be played with a mobile radio terminal are as such already known. Besides games that are already installed when purchasing the terminal, other games can also be purchased later and/or downloaded from a remote server. Online games are also known that can be played by several players connected over a mobile radio network.

EP1087312 describes furthermore a method for dynamically downloading advertising contents over a GPRS network from a remote server and reproducing them to the player during the game. The advertising content is either on the edge of the screen and/or is integrated in the game graphics.

It is an aim of the present invention to provide an improved system and method for online games.

It is in particular an aim of the present invention to provide a system and a method that make possible more efficient advertising campaigns for the displayers and new game and ordering possibilities for the players.

### BRIEF SUMMARY OF THE INVENTION

According to the present invention, these aims are achieved in particular through the elements of the characterizing part of the independent claims. Further advantageous embodiments further arise from the dependent claims and the description.

In particular, these aims are achieved through a system for games with a mobile radio network, at least one mobile telephone as game terminal with an interface for the mobile radio network and at least one gaming application, said game terminal having a portable personal identification module. An advertising content server system is provided in order to broadcast advertising contents separately from the gaming application over said mobile radio network to said game terminal. The gaming application is programmed in such a manner that advertising contents are reproduced to the player during a game and that the products or components advertised during the game can be ordered over the mobile radio network.

This has the advantage that products advertised during the game can be ordered and even delivered in electronic form. In this manner, more efficient advertising campaigns can in particular be planned, and to which the consumer can react immediately.

This method is for example well suited for installing and purchasing game components (for example new game figures, other accessories or other scenarios) during a game without having to interrupt the game, which is unwanted especially for games to which several users participate.

### BRIEF DESCRIPTION OF THE DRAWINGS

The present invention will be better understood with the aid of the description given by way of example and illustrated through the attached figures:

FIG. 1 shows a block diagram of a system according to the invention;

FIG. 2 shows a scene from an online game with advertising for components that can be downloaded;

FIG. 3 shows another screen of the online game during the ordering process of a component;

### DETAILED DESCRIPTION OF POSSIBLE EMBODIMENTS OF THE INVENTION

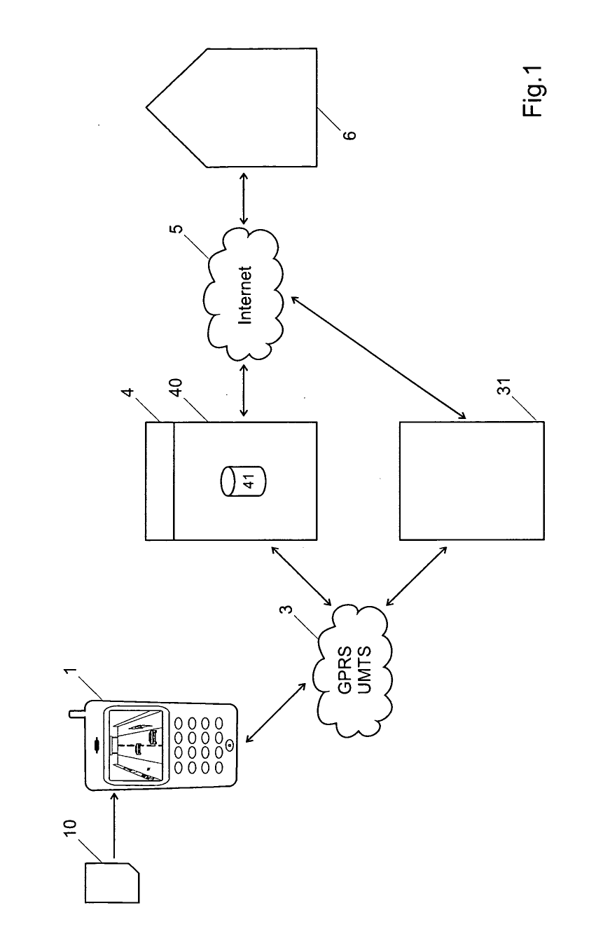

FIG. 1 shows a block diagram with the main actors or components of the system. In the represented example, the system includes a plurality of users (mobile users, players) that each have a mobile device 1. “Mobile device” in this context means both portable devices as well as devices that are connected to a fixed network but that are identified through an identification module instead of through the connection to the network.

In the following description and in the claims, the reference sign 1 refers either to the user or to the mobile device 1, except when a distinction is clearly made. The mobile devices include an identification module 10 for identifying the user in a mobile radio network. The identification module 10 is preferably personal, portable and can be separated from the mobile device; it is preferably a chip-card. The mobile device 1 can for example be a digital cellular mobile telephone (for example GSM, HSCSD, GPRS, EDGE, CDMA) or a UMTS mobile telephone, or a computer (for example a PDA) or a laptop with a contactless interface (for example with a GSMJ, HSCSD, GPRS, EDGE, CDMA, UMTS or WLAN extension card). In a variant embodiment, the mobile device 1 can also be an ad-hoc device that can establish connections in an ad-hoc network. In a further embodiment, the mobile device consists of a set-top-box for television, of a game console or of a device connected to a cable television system. The identification module 10 is for example a SIM card.

The user-mobile device 1 can be connected to a mobile network 3 to establish voice and data connections with other devices. The network has an infrastructure; infrastructure in this description and in the claims means that part of a network that is administered and controlled by the network operator, including the base station, switches, routers, home data registers, billing and payment platforms 3, servers for value-added services offered by the operator etc.

Also connected to the mobile radio network 3 is an advertising content server system 4 for broadcasting advertising contents over the mobile radio network 3 to the game terminal 1. The advertising contents can include fixed or animated image files, sound files, multimedia files, programs, applets, CORBA or SOAP components, URL links etc. and are determined by a plurality of advertising provider entities 6. The advertising provider entities can store the desired advertising content to be broadcast in the server system 4 over a secured portal, not represented (for example a WEB portal, a WAP portal, a SMS portal, a USSD handler or a voice portal) with an interactive voice recognition system (IVR, Interactive Voice Response System) and over a telecommunication network 5 (for example over the Internet 5 or over the mobile radio network 3).

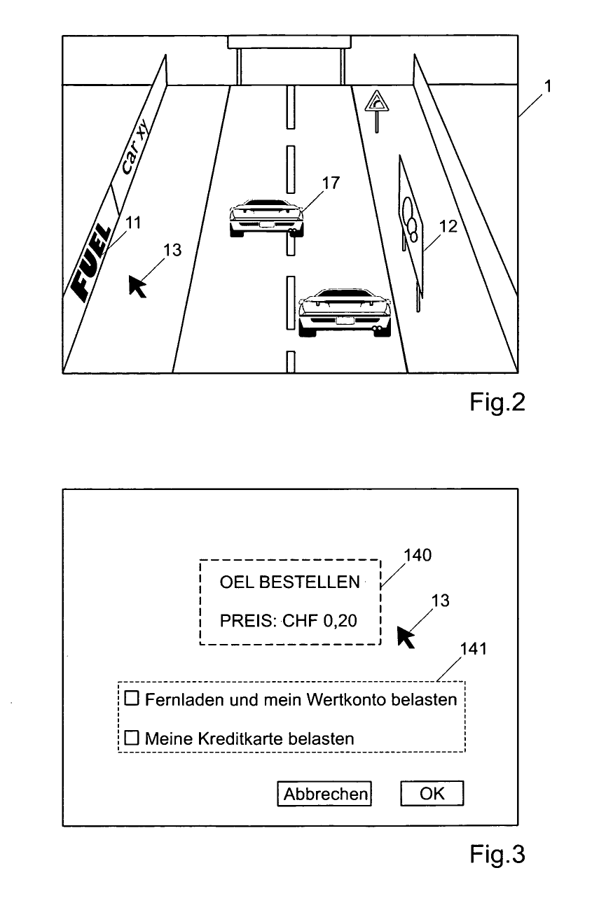

The advertising contents stored in the server 4 are transmitted separately from the gaming application over the mobile radio network 3 to the game terminal 1 and are reproduced to the player during the course of the game. FIG. 2 shows a scene of a game (here a car race) that is placed with a game terminal 1, for example with a mobile radio telephone or with a computer system connected to a mobile radio network. The scene contains a virtual car 17 controlled by the player and that is driving on a street between advertising placards 11, 12. The advertisements shown on the placards 11, 12 originate from the server 4 and are updated after distribution of the gaming application. These advertisements can be retrieved for example in pull mode when switching on the game device, when starting the gaming application or during the game from the server 4, or be sent in push mode at any time from the server 4 to the game terminals. Apart from advertising placards in a game scene, the accessories used by the game figures (for example the car, the clothes etc.) can be made to carry advertisements. Advertising contents can also be reproduced on the edge of the image, as sound file during the game, as hyperlink in the game, as animation etc.

Advertising providers 6 can store a broadcast plan for distributing their advertising contents in the memory area 41. The broadcast plan can contain for each advertising content in the server 4 one or several broadcast criteria. The broadcast criteria make the broadcasting of each item of advertising item dependent on different events, for example on the identity of the player 1, his profile (including registered interest profile), the type, display resolution and features of the terminal 1, the time, day of the week, date, location of the mobile device 1, previously sent advertisements (so that the same ad is not heard or seen twice), game development (for example achieved score) or explicit commands of the player or advertising provider. Advertising connected with broadcast criteria is then sent if the criteria are fulfilled. The broadcast can be billed to the advertising provider by the operator of the server system 4.

In this manner, advertising campaigns that are geographically and temporally restricted or dependent on the consumer profile can be planned that are addressed only a targeted audience of players. These advertising campaigns are billed to the advertising providers by a payment and billing platform 31 (for example over a known Internet or convention payment method).

As example of advertising providers 6 one can mention sellers of gaming applications that wish in this manner to offer the players game components, accessories, game extensions or new game versions. Since the advertising campaigns are geographically and temporally restricted or dependent on the consumer profile, the products can be advertised at the right point in time, in the language and currency of the player and adapted to his terminal.

A database 41 with components that can be advertised by the advertising providers 5 is also stored in the server system 4 or is connected with this server system. At least certain components in the database can be transmitted over the mobile radio network 3 to the ordering player. These components include for example files (for example game components, image, sound and multimedia files, software programs) and other objects that can be ordered by the players during a game and transmitted as a file or in a streaming process over the network 3 to the terminals 1.

FIG. 3 shows another image of the screen of the online game during the ordering process of a component. The player can arrive at this screen from the screen of FIG. 3, for example by clicking on or otherwise selecting one of the seen advertising zones with the cursor 13. The possibility of ordering a component can also be offered during certain game stages, for example at the end of a game, to offer a further episode.

The game is temporarily paused and the player has the possibility of selecting the desired products or components. In the represented example, he has the possibility of buying for his toy car, for CHF 0.20, (virtual) petrol/gas with which he can drive his car longer and/or faster. The player can also decide in a zone 141 whether this sum is to be charged to his prepaid money account or to a credit card account. The order is given simply by selecting the “OK” key; the entire customer authentication and securing of the transaction is performed on the basis of the identification module 10. After the order, the virtual petrol is downloaded, installed in the gaming application and the game can proceed.

The ordering program is advantageous among others for ordering and downloading components that influence the course of the game. For example, virtual game components (for example virtual figures, virtual weapons, virtual accessories etc.) can be bought and installed with this method without the game having to be interrupted.

Electronic components that are to be ordered and delivered with this method are preferably signed electronically by the server system 4. The signature is automatically verified in the terminal 1 so that the downloaded components are only then installed when the signature has been accepted.

With the inventive method and system, it is possible not only to order components from the database 40 but also other products and services that can possibly be delivered to the ordering player over another electronic (for example over Internet) or physical (for example post) delivery channel, either without delay or deferred. As examples, it would also be possible to order books, t-shirts, game figures etc. during a game.

The transmitted products or components can preferably be adapted automatically to the player. The version of a new program ordered in this manner can for example automatically be adapted to the player's language and to the specifications of his terminal 1. Similarly, the billed price and the billing type can be adapted automatically to the current location, the usual location, the profile and the preferences of the player.

In the frame of the invention, money amounts can also be credited to the money accounts linked to the identification card 10 (for example game winnings paid by another player or by a game provider 6). The money amount on at least one of the money accounts of the game terminal 1 is thus dependent on the outcome of the game of the gaming application in this terminal, but also in the terminals of other players. This is in particular advantageous when several players play together (respectively against one another) several games over the mobile radio network 3. If the gaming application corresponds to a competition between several players, the money amount can thus depend on the rank of the player in this competition.

The gaming application in the terminal is preferably programmed in such a fashion that the player can determine in advance or shortly before the money transfer the money account that is to be debited or recharged according to the game outcome. It is possible to use for example prepaid or postpaid money accounts of the mobile radio network 3 in which the identification module 10 is registered, and/or debit accounts, credit accounts and value accounts of other financial service providers. The money account is however preferably linked to the identification module 10. In a GSM network, the money account can thus be identified with the IMSI (International Mobile Subscriber Identity) and/or with the MSISDN (Mobile System ISDN) of the SIM card 10. If several money accounts are linked to a single identification module, an additional field can identify the money account used for the transaction.

Advantageously, a spending limit per game or per time period can furthermore be set in advance by the player and/or by third parties. As further security measures, at least certain of said money accounts can furthermore be blocked depending on the location so that money games are possible only within a certain geographic area.

According to the invention, teams of players can also be formed dynamically (for example depending on the location of the players). For this purpose, all mobile players that are currently in a geographic area are automatically combined by the server system into a team that can then play in an online game against another team. Other criteria for grouping players in teams are also conceivable in the frame of the invention. The utensils (for example the cars in a race or the t-shirts in a football game) can then be sponsored by the advertising provider entities 6.

The beginning and/or the end of a game can automatically be determined remotely for several players by a single player or by the server 4.

1. A system for games, with the following features:
a mobile radio network,
at least a mobile telephone as game terminal with an interface for the mobile radio network and at least one gaming application,
said game terminal having a portable personal identification module,
an advertising content server system for broadcasting advertising contents separately from the gaming application over said mobile radio network to said game terminal,
said gaming application being programmed in such a manner that said advertising contents are reproduced in the game to the player during a game,
characterized in that said gaming application is programmed in such a manner that products or components advertised during the game can be ordered over said mobile radio network.

2. The system of claim 1, wherein said identification module is allocated at least one money account,
said gaming application being programmed in such a manner that the money amount on at least one of said money accounts depends on the course of the game.

3. The system of claim 2, wherein said gaming application is programmed in such a manner that the money amount on at least one of said money accounts is debited after products or components advertised during the game have been ordered over said mobile radio network.

4. The system of claim 2, wherein said gaming application is programmed in such a manner that said money account is automatically recharged with game winnings.

5. The system of claim 1, wherein said gaming application is programmed in such a manner that products or components advertised during the game can be ordered without leaving the game.

6. The system of claim 2, with a plurality of said game terminals,
said gaming application being programmed in such a manner that several players can play several games together or against one another over said mobile radio network,
and said gaming application being programmed in such a manner that the money amount on at least one of said money accounts of one of the game terminals depends on the course of the game of the gaming application in at least one other game terminal.

7. The system of claim 6, wherein said gaming application is a competition between several players and wherein said money account depends on the player's rank in said competition.

8. The system of claim 2, wherein said gaming application is programmed in such a manner that the player can determine said money account that is to be debited or recharged depending on the outcome of the game.

9. The system of claim 1, wherein said gaming application is programmed in such a manner that a spending limit per game or per time period can furthermore be set per game respectively per time period.

10. The system of claim 9, wherein said spending limit is determined in advance by the player.

11. The system of claim 9, wherein said spending limit is determined by third parties.

12. The system of claim 2, wherein said money accounts include among others a prepaid or postpaid money account of the mobile radio network in which said identification modules are registered.

13. The system of claim 2, wherein said money accounts include debit accounts, credit accounts and value accounts.

14. The system of claim 2, wherein said gaming application is programmed in such a manner that components downloaded from a remote server during a game can be ordered and paid by debiting said money account.

15. The system of claim 14, wherein said components influence the course of the game.

16. The system of claim 15, wherein said components include virtual game components, for example virtual figures, virtual weapons, virtual accessories etc.

17. The system of claim 14, wherein said downloaded components are signed and only then installed when the electronic signature has been accepted.

18. The system of claim 1, wherein said advertising contents that are downloaded in a game terminal are dependent on the location of the game terminal.

19. The system of claim 1, wherein said advertising contents that are downloaded in a game terminal are dependent on the player's profile or preferences.

20. The system of claim 1, wherein said advertising contents that are downloaded in a game terminal are dependent on the achieved score of the player in the game.

21. The system of one claim 1, wherein said advertising contents that are downloaded in the advertising content server system and in the game terminal can be updated dynamically by third parties.

22. The system of claim 2, wherein at least certain said money accounts are blocked depending on the location.

23. The system of claim 1, wherein teams of players are formed dynamically.

24. The system of claim 23, wherein teams of players are formed dynamically depending on the location of the players.

25. The system of claim 1, wherein the beginning and/or the end of a game is automatically determined remotely for several players.

26. A method for playing while using a game terminal connected to a mobile radio network with the following steps:
an advertising content server system sends advertising contents over said mobile radio network to said game terminal separately from the gaming application,
said advertising contents are reproduced to the player during a game,
characterized in that advertised products or components can be ordered over said mobile radio network during the game.

27. The method of claim 26, wherein said products or components are ordered during the game and without leaving said gaming application.

28. The method of claim 27, wherein said products or components are downloaded through said mobile radio network and installed in said game terminal during the game and without leaving said gaming application.

29. The method of claim 26, wherein said products or components are paid by debiting at least one money account linked to an identification card linked to the game terminal.

30. The method of claim 26, wherein said advertising contents depend on the location of the game terminal.

31. A server system with the following components:
a connection to a telecommunication network,
a collection of advertising files designed to be integrated in video games,
a connection with a billing center for billing ordered products or services.

32. The server system of claim 31, with a broadcast planner for planning the broadcasting of said advertising files depending on events.
